(19) United States
(12) Patent Application Publication
(10) Pub. No.: US 2007/0259995 A1
(43) Pub. Date: Nov. 8, 2007

(54) Compatibilizers for composites of PVC and cellulosic materials

(76) Inventors: Peter Frenkel, Danbury, CT (US); Qinggao Ma, Naugatuck, CT (US); Paul E. Stott, Oxford, CT (US); John M. Wefer, Newtown, CT (US); Edward Krainer, New Fairfield, CT (US)

Correspondence Address: Daniel Reitenbach;CHEMTURA CORPORATION, Benson Road, Middlebury, CT, 06749, US

(21) Appl. No.: 11/418,633

(22) Filed: May 5, 2006

(51) Int. Cl. C08L 1/00

(52) U.S. Cl. 524/35

(57) ABSTRACT

A method, composition, and article of manufacture are disclosed for improving the physical properties of cellulose fiber-containing material/PVC composites by adding at least one compatibilizer to the composites. The compatibilizer is a maleated styrene/acrylonitrile copolymer.

### BACKGROUND OF THE INVENTION

1. Field of the Invention

This invention relates to the field of additives, and, more specifically, to compatibilizers for composites of poly(vinyl chloride) (PVC) and cellulosic materials used as building materials for decking, railing, window profiles, roofing shingles, fencing, siding, furniture, and the like.

2. Description of Related Art

Composites of PVC with wood and other cellulosic fibers combine the particular properties of PVC, such as high rigidity, weatherability, low flammability (PVC is a self-extinguishing material), moisture resistance, low brittleness, and low density, and those of wood or other natural fibers (low price, esthetic appeal), in such a way that a new material with desirable qualities is obtained. (See C. Bloyaert, PVC, the Definitive Choice for Sustainable Natural Fiber Composites, The 9th International PVC Conference, Brighton, U.K. (2005); and H. Jiang and D. Pascal Kamdem, Development of PVC/Wood Composites—A Literature Review, 10 J. VINYL ADD. TECHN. 59 (2004), and references cited therein.) Applications for wood-PVC include decking, railing, fencing, window profiles, doors, and flooring.

Wood-PVC composites have higher flexural modulus than PVC alone (see Bloyaert and Jiang et al., supra). Flexural strength, however, is lower than that for PVC (see Jiang et al., supra, and F. M. Meneloglu, L. M. Matuana, J. A. King, 6 J. VINYL ADDIT. TECHNOL. 153 (2000)).

Improvement of mechanical properties is always desirable for composite materials, and it will lead to more durable materials that will also require less maintenance. The properties can be improved by the use of a compatibilizer. Possible approaches to improving mechanical properties by increasing adhesion between wood or cellulose and PVC include sizing (of wood or cellulose) and compatibilization. “Sizing” is the treatment of the fibers prior to their incorporation into the compound; “compatibilization” refers to an additive (compatibilizer) blended into the compound in order to enhance the mechanical properties of the final product. Wood sizing agents for wood-PVC that have been described include: silanes, silane/peroxide blends, polyisocyanates, mercaptans, maleic anhydride and phthalic anhydride with peroxides, maleated polypropylene/benzoyl peroxide, metallic complexes, such as chromated copper arsenate or copper ethanolamine, grafting acrylonitrile on wood flour (see Jiang et al., supra). Other materials reported as coupling agents include: chitin and chitosan (see B. L. Shah, L. M. Matuana, and P. A. Heiden, Novel Coupling Agents for PVC/Wood-Flour Composites,” ANTEC 2005, USA), acrylic acid-functionalized polyethylene (PE) and maleic anhydride-functionalized PE (see Q. Li and L. M. Matuana, Surface of Cellulosic Materials Modified with Functionalized Polyethylene Coupling Agents, 88 J. APPL. POLYM. SCI. 278-86 (2003)), phthalic anhydride, maleic anhydride, and linoleic acid (Jiang et al., supra).

U.S. Pat. Nos. 5,322,912, 5,401,804, and 5,549,998 disclose a free radical polymerization process for the preparation of a thermoplastic resin or resins comprising heating a mixture of a free radical initiator, a stable free radical agent, and at least one polymerizable monomer compound to form a thermoplastic resin or resins with a high monomer to polymer conversion; cooling said mixture; optionally isolating the thermoplastic resin or resins; and optionally washing and drying thermoplastic resin or resins. Related free radical processes are also disclosed for the preparation of mixtures and block copolymer thermoplastic resins. Resins prepared by the disclosed processes are said to possess a narrow polydispersity and a modality that is controlled by the selection of a free radical initiator and stable free radical agent addition step or steps.

U.S. Pat. Nos. 5,530,079 and 5,610,250 disclose a polymerization process comprising: heating a mixture comprised of a free radical initiator, a stable free radical agent, at least one polymerizable monomer compound, and optionally a solvent, to form a polymer with a high monomer to polymer conversion and a narrow polydispersity, wherein said polymer is comprised of a covalently bound free radical initiator fragment at one end and a covalently bound stable free radical compound at the other end of the polymer, and wherein said stable free radical agent has high thermal, acidic, and photochemical stability.

U.S. Pat. No. 5,739,229 discloses a process for the preparation of thermoplastic resin comprising: heating a mixture comprised of a free radical initiator, a stable free radical agent, at least one polymerizable monomer compound and an electron acceptor (EA) compound, to form a thermoplastic resin containing a homopolymeric segment or segments and wherein said process possesses a high monomer to polymer conversion and a narrow polydispersity.

U.S. Pat. No. 6,156,858 discloses a process for the preparation of a polymer comprising heating a mixture comprised of a free radical initiator, a stable free radical agent, a base selected from the group consisting of inorganic bases and organic bases, and at least one polymerizable monomer compound and optionally cooling, followed by optionally isolating the polymer product.

U.S. Pat. No. 6,258,911 discloses a polymer having groups located at the ends of the polymer chain which groups are derived from stable free radical compounds, wherein the polymer is of the formula: SFR—(R)—SFR wherein SFR represents a covalently bonded stable free radical group and R represents a thermoplastic resin.

The disclosures of the foregoing are incorporated herein by reference in their entirety.

### SUMMARY OF THE INVENTION

Block copolymers of styrene, maleic anhydride (MA), and acrylonitrile (AN) can be prepared by a controlled living free radical polymerization (CLFRP) using benzoyl peroxide as initiator and a stable nitroxide, 4-oxo-2,2,6,6-tetramethyl-1-piperidinyloxy (4-oxo TEMPO), as regulator, according to a procedure disclosed in U.S. Pat. Nos. 5,322,912, 5,401,804, 5,530,079, 5,549,998, 5,610,250, 5,739,229, 6,156,858, and 6,258,911, supra. In these block copolymers, the maleic anhydride is present in the polymer as a block, i.e., a gradient polymer with almost all the maleic anhydride at the chain front. Typically, the AN content in the final polymer is between 22 and 30 percent (wt %); the MA content in the final polymer between 3 and 15 units per chain; and the number average molecular weight is between 50,000 and 100,000.

According to the current invention, the maleated SAN (MA-SAN) so obtained is used as a compatibilizer for cellulose fiber-PVC (which term is intended to include wood-PVC) composites. Specifically, the present invention relates to the use of a maleated SAN compatibilizer or coupling agent to improve the flexural properties, such as flexural modulus and strength, of cellulose fiber-containing PVC composites. Such cellulose fiber-containing materials can include, but are not limited to, cellulose, cellulose derivatives, wood fibers, wood flour, flax, kenaf, sisal, jute, rice hulls, cotton, hemp, and the like. Preferred cellulose fiber-containing materials are selected from the group consisting of wood flour, wood fiber, and natural fibers, such as flax, rice hulls, sisal, jute, and kenaf. Preferably, the compatibilizer is used at a level of from about 0.1 to about 90 phr (parts per hundred parts of resin), more specifically from about 1.0 to about 15.0 phr.

More particularly, the present invention is directed to a method for improving the physical properties of cellulose fiber-containing material/PVC composites comprising adding to said composites an effective amount of at least one compatibilizer comprising a maleated styrene/acrylonitrile copolymer.

In another aspect, the present invention is directed to a composition comprising a cellulose fiber-containing material/PVC composite and at least one compatibilizer comprising a maleated styrene/acrylonitrile copolymer.

In still another aspect, the present invention is directed to an article of manufacture comprising a composition comprising a cellulose fiber-containing material/PVC composite and at least one compatibilizer comprising a maleated styrene/acrylonitrile copolymer.

### DESCRIPTION OF THE PREFERRED EMBODIMENT(S)

As noted above, the present invention is directed to a method for improving the flexural properties of cellulose fiber-PVC composites comprising adding to said composites an effective amount of at least one compatibilizer comprising a maleated styrene/acrylonitrile copolymer.

The maleated stryrene/acrylonitrile copolymers employed in the practice of the present invention can be prepared by processes known in the art.

As described in U.S. Pat. No. 5,322,912, a free radical polymerization process can be used for the preparation of a block copolymer thermoplastic resin or resins wherein the process comprises heating a first mixture comprised of a free radical initiator, a stable free radical agent, and at least one polymerizable monomer compound to form a first intermediate product resin; optionally cooling the first mixture; optionally isolating the first intermediate product resin; adding to the first intermediate product resin a second mixture comprised of at least one polymerizable monomer compound, wherein the polymerizable monomer compound of the second mixture is different from the polymerizable monomer compound of the first mixture, to form a combined mixture; heating the combined mixture to form a third mixture comprised of a block copolymer thermoplastic resin comprised of a first product resin formed from the first intermediate product resin and added the second monomer; cooling the third mixture; optionally isolating the block copolymer thermoplastic resin from the third mixture; and optionally washing and drying the block copolymer thermoplastic resin.

The compatibilizing agents employed in the practice of the present invention can be incorporated into the composite in any of several ways. For example, the agent can first be mixed with the PVC and then the natural fiber can be added to the mixture. Alternatively, the agent can first be mixed with the natural fiber and then the PVC can be added to the mixture. In another alternative, the PVC and the natural fiber are first blended together and then the agent is added to the blend. In still another alternative, all three components are mixed together simultaneously, as, for example, in an extruder.

As employed herein, the term poly(vinyl chloride), or PVC, is intended to include both homopolymers and copolymers of vinyl chloride, i.e., vinyl resins containing vinyl chloride units in their structure, e.g., copolymers of vinyl chloride and vinyl esters of aliphatic acids, in particular vinyl acetate; copolymers of vinyl chloride with esters of acrylic and methacrylic acid and with acrylonitrile; copolymers of vinyl chloride with diene compounds and unsaturated dicarboxylic acids or anhydrides thereof, such as copolymers of vinyl chloride with diethyl maleate, diethyl fumarate or maleic anhydride; post-chlorinated polymers and copolymers of vinyl chloride; copolymers of vinyl chloride and vinylidene chloride with unsaturated aldehydes, ketones and others, such as acrolein, crotonaldehyde, vinyl methyl ketone, vinyl methyl ether, vinyl isobutyl ether, and the like.

The term “PVC” as employed herein is also intended to include graft polymers of PVC with EVA, ABS, and MBS. Preferred substrates are also mixtures of the above-mentioned homopolymers and copolymers, in particular vinyl chloride homopolymers, with other thermoplastic and/or elastomeric polymers, in particular blends with ABS, MBS, NBR, SAN, EVA, CPE, MBAS, PMA, PMMA, EPDM, and polylactones.

Within the scope of this invention, PVC will also be understood to include recyclates of halogen-containing polymers, which are the polymers described above in more detail and which have suffered damage by processing, use or storage. PVC recyclate is particularly preferred. The recyclates may also contain minor amounts of foreign materials, typically paper, pigments, adhesives or other polymers, which are often difficult to remove. These foreign materials can also originate from contact with different substances during use or working up, for example fuel residues, paint components, metal traces, initiator residues, and water traces.

The primary requirement for the PVC material is that it retain sufficient thermoplastic properties to permit flux melt blending with wood and other natural fibers, permit formation of linear extrudate pellets, and to permit the composition material or pellet to be extruded or injection molded in a thermoplastic process forming a rigid structural member. PVC homopolymers, copolymers, and polymer alloys are available from a number of manufacturers including B.F. Goodrich, Vista, Air Products, Occidental Chemicals, etc. Preferred poly(vinyl chloride) materials are PVC homopolymers having molecular weights of about 10,000 to 250,000, preferably about 20,000 to 90,000.

Suitable biofibers for use in the practice of the present invention may be derived from any of a number of available sources, such as ground wood, sawdust, wood flour, ground newsprint, magazines, books, cardboard, wood pulps (mechanical, stone ground, chemical, mechanical-chemical, refined, bleached or unbleached, virgin or recycled, sludge, waste fines), and various agricultural wastes (rice hulls, wheat, oat, barley and oat chaff, coconut shells, peanut shells, walnut shells, straw, corn husks, corn stalks, jute, hemp, bagasse, bamboo, flax, and kenaf).

Wood fiber, which is preferred because of its abundance and suitability, can be derived from either soft woods or evergreens or from hard woods commonly known as broad leaf deciduous trees. Soft woods are generally preferred for fiber manufacture because the resulting fibers are longer and contain higher percentages of lignin and lower percentages of hemicellulose than hard woods. While soft wood is the primary source of fiber for use in the practice of the present invention, additional fiber make-up can be derived from a number of secondary or fiber reclaim sources, including bamboo, rice, sugar cane, flex, kenaf, and recycled fibers from newspapers, boxes, computer printouts, and the like.

A preferred source for wood fiber comprises the wood fiber by-product of sawing or milling soft woods commonly known as sawdust or milling tailings. Such wood fiber has a regular reproducible shape and aspect ratio. The fibers are commonly at least 0.1 mm in length, at least 0.01 mm in thickness and commonly have an aspect ratio of at least 1.8. Preferably, the fibers are 0.2 to 10 mm in length, 0.02 to 1.5 mm in thickness with an aspect ratio between 2 and 7, preferably 2.5 to 6.0. The preferred fiber is derived from processes common in the manufacture of windows and doors. Wooden members are commonly ripped or sawed to size in a cross grain direction to form appropriate lengths and widths of wood materials. The by-product of such sawing operations is a substantial quantity of sawdust. In shaping a regular shaped piece of wood into a useful milled shape, wood is commonly passed through machines that selectively remove wood from the piece leaving the useful shape. Such milling operations produce substantial quantities of sawdust or mill tailing by-products. Lastly, when shaped materials are cut to size and mitered joints, butt joints, overlapping joints, mortise and tenon joints are manufactured from pre-shaped wooden members, substantial waste trim is produced. Such large trim pieces are commonly cut and machined to convert the larger objects into wood fiber having dimensions approximating sawdust or mill tailing dimensions. The wood fiber sources can be blended regardless of particle size and used to make the composite. The fiber stream can be pre-sized to a preferred range or can be sized after blending. Further, the fiber can be pre-pelletized before use in composite manufacture.

The poly(vinyl chloride) and cellulose fiber can be combined and formed into pellets using, for example, thermoplastic extrusion processes, and the fiber can be introduced into the pellet making process in a number of sizes. Preferably, wood fiber should have a minimum size of length and width of at least about 1 mm because wood flour tends to be explosive at certain wood to air ratios. Further, wood fiber of appropriate size of an aspect ratio greater than 1 tends to increase the physical properties of the extruded structural member. However, useful structural members can be made with fibers of very large size. Fibers that are up to 3 cm in length and 0.5 cm in thickness can be used as input to the pellet or linear extrudate manufacture process. However, particles of this size do not produce the highest quality structural members or maximized structural strength. Further, large particle wood fibers can be reduced in size by grinding or other similar processes that produce a fiber similar to sawdust having the stated dimensions and aspect ratio. One further advantage of manufacturing sawdust of the desired size is that the material can be pre-dried before introduction into the pellet or linear extrudate manufacturing process. Further, wood fiber can be pre-pelletized into pellets of wood fiber with small amounts of binder if necessary.

During the pelletizing process for the composite pellet, the PVC and fiber are intimately contacted at high temperatures and pressures to ensure that the fiber and polymeric material are wetted, mixed, and extruded in a form such that the polymer material, on a microscopic basis, coats and flows into the pores, cavities, etc., of the fibers. The fibers are preferably substantially oriented by the extrusion process in the extrusion direction. Such substantial orientation causes the overlapping of adjacent parallel fibers and the polymeric coating of the oriented fibers, resulting in a material useful for the manufacture of improved structural members having improved physical properties. The degree of orientation is typically about 20 percent, preferably 30 percent above random orientation, which is about 45 to 50 percent, said orientation being percents above the normal orientation.

Moisture control is an important element of manufacturing a useful linear extrudate or pellets. Depending on the equipment used and processing conditions, control of the water content of the linear extrudate or pellet can be important in forming a successful structural member substantially free of internal voids or surface blemishes. The concentration of water present in sawdust during the formation of pellets or linear extrudate when heated can flash from the surface of a newly extruded structural member and can come as a result of a rapid volatilization, form a steam bubble deep in the interior of the extruded member that can pass from the interior through the hot thermoplastic extrudate leaving a substantial flaw. In a similar fashion, surface water can bubble and leave cracks, bubbles, or other surface flaws in the extruded member.

Because of the variation in water content of wood fiber sources and the sensitivity of extrudate to water content, control of water to a level of less than 8 weight percent in the pellet based on pellet weight can be important. When structural members are extruded in a non-vented extrusion process, the pellet should be as dry as possible and have a water content between about 0.01 and about 5 weight percent, preferably less than 1 weight percent. When using vented equipment in manufacturing the extruded linear member, a water content of less than about 8 weight percent can be tolerated if processing conditions are such that the vented extrusion equipment can dry the thermoplastic material prior to the final formation of the structural member at the extrusion head. The pellets or linear extrudate of the invention can be made by extrusion of the PVC and fiber composite through an extrusion die resulting in a linear extrudate that can be cut into a pellet shape. The pellet cross-section can be any arbitrary shape depending on the extrusion die geometry.

Depending on their end use requirement, the compositions employed in the practice of the present invention can also contain further additives and stabilizers, typically potassium, sodium, calcium, magnesium, and barium soaps or tin derivatives, as well as, inter alia, process aids, fusion promoters, plasticizers, epoxide compounds, metal perchlorates, lubricants, waxes, impact modifiers, fillers, reinforcing agents, antioxidants, polyols, dawsonites, hydrotalcites, organic phosphites, 1,3-diketo compounds, mono-, oligo- or polymeric dihydropyridines, sterically hindered amines (HALS), light stabilisers, UV absorbers, fatty acid esters, paraffins, blowing agents, fluorescent whitening agents, pigments, flame retardants, antistatic agents, aminocrotonates, thiophosphates, gelling assistants, metal deactivators, peroxide scavenging compounds, modifiers and further sequestrants for Lewis acids, and the like, as is known in the art. (See, for example, U.S. Pat. No. 6,531,533, the disclosure of which is incorporated herein by reference in its entirety.) Preferred additives are selected from the group consisting of heat stabilizers, lubricants, impact modifiers, processing aids, antioxidants, fillers, pigments, and mold release agents.

Where fusion promoters, process aids, and lubricants are included in the composites of the present invention, they can be, but are not limited to, for example, calcium stearate, montan wax, fatty acid esters, polyethylene waxes, chlorinated polyethylene, chlorinated hydrocarbons, oxidized polyethylene, methyl methacrylate-styrene-acrylonitrile resin, glycerol esters, combinations thereof, and the like. Where impact modifiers are included in the composites of the present invention, they can be, but are not limited to, for example, chlorinated polyolefins such as chlorinated polyethylene, EVA copolymers, acrylic or modified acrylic resins, MBS copolymers, MABS copolymers, calcium carbonate, alumina trihydrate, combinations thereof, and the like. Where fillers are included in the composites of the present invention, they can be, but are not limited to, for example, calcium carbonate, talc, calcined kaolin, mica, feldespar, wollastonite, silica, glass, barite, calcium sulfate, titanium dioxide, combinations thereof, and the like.

Various features and aspects of the present invention are illustrated further in the examples that follow. While these examples are presented to show one skilled in the art how to operate within the scope of the invention, they are not intended in any way to serve as a limitation upon the scope of the invention.

### EXAMPLES

In the current invention maleated styrene/acrylonitrile copolymer (MA-SAN), together with other additives such as process aids, fusion promoters, lubricants, impact modifiers, stabilizers, was added to the compound prior to high speed mixing. The “compound” referred to is a mixture of resin, filler which in this case was refined cellulose fiber, and any other ingredients or additives in the formulation. The dry blend compound was then processed either by extrusion or it was milled in a two-roll mill and specimens were prepared from milled sheets by compression molding. Extruded or molded specimens were then tested for flexural strength and flexural modulus.

Additionally, coupling of PVC to pine wood was tested by measuring the adhesion strength of polymer compressed to strips of wood with and without a film of MA-SAN between the PVC and the wood. The validity of this test was confirmed by data showing that films of Polybond 3039, a commercial coupling agent for wood-PE composites, improve the adhesion of HDPE to wood (see below).

Specifically, two PVC formulations were used for making the composites, the main difference between them being in the kind of lubricants used. Formulation 1 included calcium stearate as a lubricant, whereas formulation 2 did not. The MA-SAN used had a molecular weight of approximately 50,000 to 60,000 Da, had about 30 percent of acrylonitrile, and was maleated to the extent of about nine units per chain. Cellulose fibers used were Createch TC 750, a commercial product from Creafill Fibers Corp. (Chestertown, Md.). The fibers were dried in an oven at 80° C. for three days before use. The ratio of cellulose fibers to PVC compound was 40/60. Specimens were 0.5 inch wide by 0.13 inch thick and were tested according to ASTM D 790-92. Results of the tests are shown below.

TABLE 1
Flexural Properties of Extruded Samples

| | | | | | |
|---|---|---|---|---|---|
| | MA-SAN | Peak Stress | Percent | Modulus | Percent |
| Example | (phr) | (psi) | Change | (psi) | Change |

Formulation 2

| | | | | | |
|---|---|---|---|---|---|
| A | 0 | 8,699 | 0 | — | — |
| B | 3 | 9,530 | 9.5 | — | — |
| C | 6 | 10,169 | 17 | — | — |

Formulation 1

| | | | | | |
|---|---|---|---|---|---|
| D | 0 | 8,423 | 0 | 718,204 | 0 |
| E | 3 | 10,699 | 27 | 765,227 | 7.9 |

TABLE 2
Flexural Properties of Compression Molded Samples

| | | | | | |
|---|---|---|---|---|---|
| | MA-SAN | Peak Stress | Percent | Modulus | Percent |
| Example | (phr) | (psi) | Change | (psi) | Change |

Formulation 2

| | | | | | |
|---|---|---|---|---|---|
| A | 0 | 11,271 | 0 | 886,759 | 0 |
| B | 3 | 14,645 | 30 | 1,243,573 | 40 |

Samples for adhesion tests were prepared by the compression molding of 1 mm thick rigid PVC strips against ¼ inch thick sanded pine wood strips at 177° C. and 5,000 psi for five minutes. One inch wide specimens were obtained and a 90 degree angle peel strength test was then carried out, measuring the force necessary to pull the PVC film apart from the wood strip. The PVC used (Formulation 1) was reinforced with cross woven fabric during compression in order to avoid breakage of the film resulting from the brittleness of PVC. The MA-SAN (Example A) had a MW of 50,000-60,000 Da, and comprised about 30 percent acrylonitrile. It was maleated to about nine units per chain. Example B had a MW of about 100,000, 26 percent acrylonitrile, and 15 MA units per chain. Blendex 563 is an SAN with a MW and acrylonitrile content roughly similar to Example B. Adhesion of PVC to wood was stronger with MA-SAN film than the controls with no film or with SAN (Table 3).

TABLE 3
90° Angle Peel Test of Polymer Coating Bonded to Pine Wood

| Polymer | Adhesive Film | Load (lbf) |
|---|---|---|
| PVC (reinforced) | — | 0.5 |
| PVC (reinforced) | MA-SAN (Example A) | 3.3 |
| PVC (reinforced) | Blendex 563 (SAN) | 0.95 |
| PVC (reinforced) | MA-SAN (Example B) | 2.1 |
| HDPE | — | 2.5 |
| HDPE | Polybond 3039 | 5.2 |

In view of the many changes and modifications that can be made without departing from principles underlying the invention, reference should be made to the appended claims for an understanding of the scope of the protection to be afforded the invention.

What is claimed is:

1. A method for improving the physical properties of cellulose fiber-containing material/PVC composites comprising adding to said composites an effective amount of at least one compatibilizer comprising a maleated styrene/acrylonitrile copolymer.

2. The method of claim 1, wherein the maleated styrene/acrylonitrile copolymer is a block copolymer.

3. The method of claim 2, wherein the maleated styrene/acrylonitrile copolymer is comprised of about 22 to 30% by weight of acrylonitrile and at least 3 maleic anhydride units per chain and not more that 15 maleic anhydride units per chain.

4. The method of claim 2, wherein the maleated styrene/acrylonitrile copolymer has a number average molecular weight between 50,000 and 100,000.

5. The method of claim 1, wherein the cellulose fiber-containing material is selected from the group consisting of wood flour, wood fiber, refined cellulose fiber, virgin or recycled, flax, rice hulls, sisal, jute, and kenaf.

6. The method of claim 1, wherein the compatibilizer is used at a level from about 0.1 to 90.0 phr.

7. The method of claim 1, wherein the composites further comprise at least one additive selected from the group consisting of heat stabilizers, lubricants, impact modifiers, processing aids, antioxidants, other conventional fillers, pigments, and mold release agents.

8. A composition comprising a cellulose fiber-containing material/PVC composite and at least one compatibilizer comprising a maleated styrene/acrylonitrile copolymer.

9. The composition of claim 8, wherein the maleated styrene/acrylonitrile copolymer is a block copolymer.

10. The composition of claim 9, wherein the maleated styrene/acrylonitrile copolymer is comprised of about 22 to 30% by weight of acrylonitrile and at least 3 maleic anhydride units per chain and not more that 15 maleic anhydride units per chain.

11. The composition of claim 9, wherein the maleated styrene/acrylonitrile copolymer has a number average molecular weight between 50,000 and 100,000.

12. The composition of claim 8, wherein the cellulose fiber-containing material is selected from the group consisting of wood flour, wood fiber, refined cellulose fiber, virgin or recycled, flax, rice hulls, sisal, jute, and kenaf.

13. The composition of claim 8, wherein the compatibilizer is used at a level from about 0.1 to about 90 phr.

14. The composition of claim 8, wherein the composites further comprise at least one additive selected from the group consisting of heat stabilizers, lubricants, impact modifiers, processing aids, antioxidants, other conventional fillers, pigments, and mold release agents.

15. An article of manufacture comprising a composition comprising a cellulose fiber-containing material/PVC composite and at least one compatibilizer comprising a maleated styrene/acrylonitrile copolymer.

16. The article of manufacture of claim 15, wherein the maleated styrene/acrylonitrile copolymer is a block copolymer.

17. The article of manufacture of claim 16, wherein the maleated styrene/acrylonitrile copolymer is comprised of about 22 to 30% by weight of acrylonitrile and at least 3 maleic anhydride units per chain and not more that 15 maleic anhydride units per chain.

18. The article of manufacture of claim 16, wherein the maleated styrene/acrylonitrile copolymer has a number average molecular weight between 50,000 and 100,000.

19. The article of manufacture of claim 15, wherein the cellulose fiber-containing material is selected from the group consisting of wood flour, wood fiber, refined cellulose fiber, virgin or recycled, flax, rice hulls, sisal, jute, and kenaf.

20. The article of manufacture of claim 8, wherein the compatibilizer is used at a level from about 0.1 to about 90 phr.
